(19) United States
(12) Patent Application Publication
(10) Pub. No.: US 2011/0195714 A1
(43) Pub. Date: Aug. 11, 2011

(54) METHODS AND APPARATUS FOR PERFORMING REGISTRATION ACROSS RADIO ACCESS TECHNOLOGIES

(75) Inventor: Arvind Sawinathan, San Diego, CA (US)

(73) Assignee: QUALCOMM Incorporated, San Diego, CA (US)

(21) Appl. No.: 13/020,695

(22) Filed: Feb. 3, 2011

Related U.S. Application Data
(60) Provisional application No. 61/301,899, filed on Feb. 5, 2010.

(51) Int. Cl. H04W 60/00

(52) U.S. Cl. 455/435.1

(57) ABSTRACT

Methods and apparatuses are provided that facilitate balancing cross-domain paging with registrations performed by a device moving between multiple networks. A device communicating in idle-mode with one or more base stations can obtain one or more parameters regarding a base station using a radio access technology (RAT) to control whether the device performs registration on a network of a different RAT. Thus, the device moving from an area of coverage from one base station of the RAT to a different area that includes coverage from another base station of the different RAT (or vice versa) can determine whether and/or when to perform a registration on the network of the different RAT for receiving paging signals related to the different RAT based at least in part on the one or more parameters.

### CLAIM OF PRIORITY UNDER 35 U.S.C. §119

The present application for patent claims priority to Provisional Application No. 61/301,899 entitled “METHODS AND APPARATUS TO FORCE REGISTRATION ACROSS 1X-LTE BOUNDARIES” filed Feb. 5, 2010, and assigned to the assignee hereof and hereby expressly incorporated by reference herein.

### BACKGROUND

1. Field

The following description relates generally to wireless network communications, and more particularly to performing registrations for using different radio access technologies.

2. Background

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), evolution data optimized (EV-DO), etc.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth. In addition, mobile devices can communicate with other mobile devices (and/or base stations with other base stations) in peer-to-peer wireless network configurations.

In addition, LTE has been deployed in certain areas for high-speed data communications, and the areas can also include circuit switched network coverage. In some implementations, LTE networks do not directly support voice communications, and thus a device can fallback to a circuit switched network in the coverage area to perform voice communications, short message service (SMS), etc. In this regard, a device communicating over an LTE network or other packet switched network can also register with a circuit switched network (such as code division multiple access 2000 1x, Global System for Mobile Communications, Universal Mobile Telecommunication System, etc.) through the LTE network. Thus, if a call is received for a device camped on the LTE network in idle-mode, the LTE network can forward or otherwise send a page related to the circuit switched network to the device, and the device can fallback to the circuit switched network in a similar coverage area based on receiving the page to facilitate voice communications. Similarly, the device can fallback to the circuit switched network to initiate voice communications.

Moreover, due to sporadic LTE deployment, a device can move between areas of combined circuit switched network and LTE coverage and areas of circuit switched network coverage with no LTE while in idle-mode. Thus, a device can drop out of LTE coverage and over to circuit switched network coverage. In this example, however, the LTE network can still transmit paging signals to the device for incoming calls, SMS, etc. along with the circuit switched network resulting in cross-domain paging where the LTE page is not utilized. This can cause unnecessary use of network resources for the LTE deployment.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more embodiments and corresponding disclosure thereof, various aspects are described in connection with facilitating balancing unnecessary cross-domain paging with performing registrations when moving between multiple networks. For example, a device communicating in idle-mode with one or more base stations can obtain one or more parameters regarding a base station using a radio access technology (RAT) to control whether the device performs registration on a network of a different RAT. Thus, the device moving from an area of coverage from one base station of the RAT to a different area that includes coverage from another base station of the different RAT (or vice versa) can determine whether and/or when to perform a registration on the network of the different RAT for receiving paging signals related to the different RAT

In one example, the device can be able to store registrations for each of networks of the RAT and different RAT, and can determine whether to perform a registration on the network of the different RAT based at least in part on a parameter received from the network of the RAT. In another example, both networks can be capable of transmitting paging signals to the idle-mode device, and the device can determine whether to perform the registration on the network of the different RAT further based at least in part on analyzing a timer to prevent frequent switching between the networks.

According to an example, a method operable by a device in wireless communications is provided that includes determining a value for a predetermined registration tracking parameter from a base station of a first RAT and determining whether to perform a registration for a second RAT based at least in part on the value for the predetermined registration tracking parameter.

In another aspect, an apparatus operable in wireless communications is provided that includes at least one processor configured to determine a value for a predetermined registration tracking parameter from a base station of a first RAT. The at least one processor is further configured to determine whether to update a registration status for a second RAT based at least in part on the value for the predetermined registration tracking parameter. In addition, the apparatus includes a memory coupled to the at least one processor.

In yet another aspect, an apparatus operable in wireless communications is provided that includes means for determining a value for a predetermined registration tracking parameter from a base station of a first RAT. The apparatus further includes means for determining whether to update a registration status for a second RAT based at least in part on the value for the predetermined registration tracking parameter.

Still, in another aspect, a computer-program product used in wireless communications is provided including a computer-readable medium having code for causing at least one computer to determine a value for a predetermined registration tracking parameter from a base station of a first RAT. The computer-readable medium further includes code for causing the at least one computer to determine whether to update a registration status for a second RAT based at least in part on the value for the predetermined registration tracking parameter.

Moreover, in an aspect, an apparatus operable in wireless communications is provided that includes a parameter determining component for determining a value for a predetermined registration tracking parameter from a base station of a first RAT. The apparatus further includes a registration determining component for determining whether to update a registration status for a second RAT based at least in part on the value for the predetermined registration tracking parameter.

According to another example, a method operable by a device a wireless network is provided that includes detecting switching from idle-mode to active-mode communications and determining that a time between a current time and a time for updating a registration status with a RAT is less than a threshold time. The method further includes updating the registration status with the RAT while in active-mode communications based at least in part on the determining.

In another aspect, an apparatus operable in a wireless network is provided that includes at least one processor configured to detect switching from idle-mode to active-mode communications and determine that a time between a current time and a time for updating a registration status with a RAT is less than a threshold time. The at least one processor is further configured to update the registration status with the RAT while in active-mode communications based at least in part on the at least one processor determining the time between the current time and the time for updating the registration status is less than the threshold time. In addition, the apparatus includes a memory coupled to the at least one processor.

In yet another aspect, an apparatus operable in a wireless network is provided that includes means for detecting switching from idle-mode to active-mode communications and determining that a time between a current time and a time for updating a registration status with a RAT is less than a threshold time. The apparatus further includes means for updating the registration status with the RAT while in active-mode communications based at least in part on the means for detecting determining that the time between the current time and the time for updating the registration status is less than the threshold time.

Still, in another aspect, a computer-program product used in a wireless network is provided including a computer-readable medium having code for causing at least one computer to detect switching from idle-mode to active-mode communications and code for causing the at least one computer to determine that a time between a current time and a time for updating a registration status with a RAT is less than a threshold time. The computer-readable medium further includes code for causing the at least one computer to update the registration status with the RAT while in active-mode communications based at least in part on the code for causing the at least one computer to determine determining the time between the current time and the time for updating the registration status is less than the threshold time.

Moreover, in an aspect, an apparatus operable a wireless network is provided that includes a registration determining component for detecting switching from idle-mode to active-mode communications and determining that a time between a current time and a time for updating a registration status with a RAT is less than a threshold time. The apparatus further includes a registering component for updating the registration status with the RAT while in active-mode communications based at least in part on the means for detecting determining that the time between the current time and the time for updating the registration status is less than the threshold time.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example system for moving among one or more coverage areas of one or more radio access technology (RAT).

FIG. 2 illustrates an example system for determining whether to perform registration with a RAT when moving communications among base stations.

FIG. 3 illustrates an example system for receiving a band class value related to a RAT and determining whether to perform registration based at least in part on the value.

FIG. 4 illustrates an example system for receiving a tracking area code value related to a RAT and determining whether to perform registration based at least in part on the value.

FIG. 5 illustrates an example methodology that determines whether to perform registration over a RAT based at least in part on a band class value.

FIG. 6 illustrates an example methodology that determines whether to perform registration over a RAT based at least in part on a tracking area code value.

FIG. 7 illustrates an example methodology that determines whether to perform registration over a RAT based at least in part on a timer value and a wildcard band class.

FIG. 8 illustrates an example methodology that determines whether to update a registration status while in active-mode.

FIG. 9 illustrates an example mobile device that determines whether to perform registration over a RAT.

FIG. 10 illustrates an example system that facilitates advertising one or more parameters in system information.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As described further herein, a base station of a radio access technology (RAT) can provide parameters to control whether a device registers on a network of a different RAT. For example, devices in idle-mode moving between areas of coverage of the RAT and different RAT can determine whether to perform a registration over the network of the different RAT (e.g., whether communicating with a base station of the RAT or different RAT) based at least in part on the parameters. In one example, the device can further determine whether to perform registrations on the network of the different RAT based at least in part on a timer to prevent repeated registrations using base stations of the RAT and different RAT.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, evolved Node B (eNB), or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

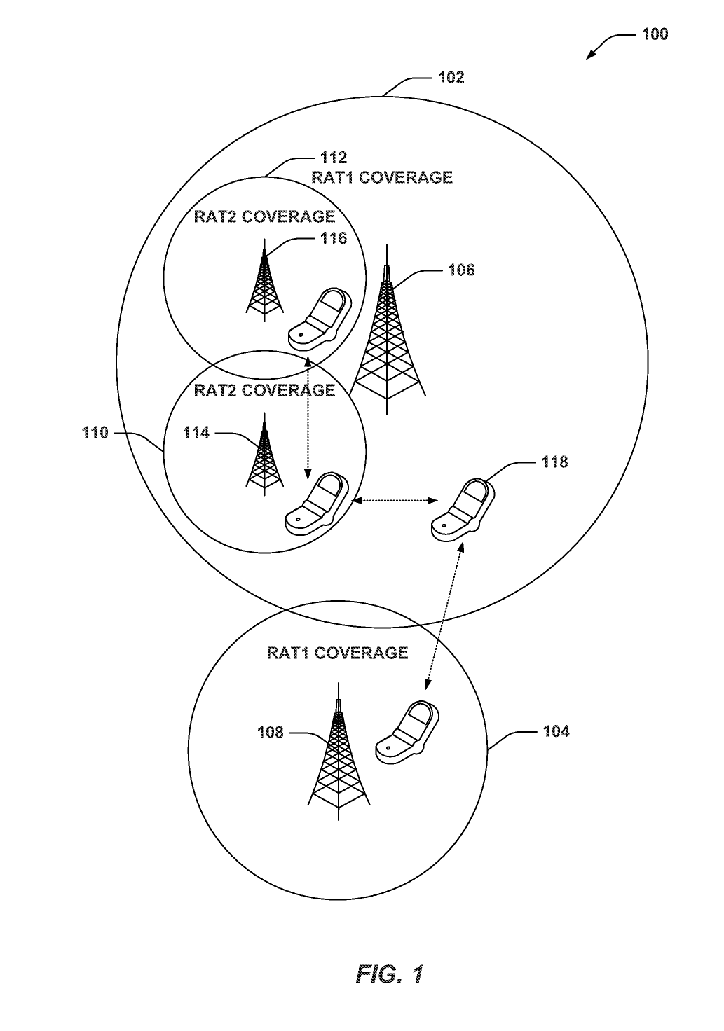

Referring to FIG. 1, illustrated is a wireless communication system 100 that facilitates controlling device registration for moving between differing network coverage areas. System 100 comprises RAT1 coverage areas 102 and 104 provided respectively by base stations 106 and 108, and RAT2 coverage areas 110 and 112 provided by base stations 114 and 116 that are at least partially within RAT1 coverage area 102. System 100 also includes a device 118 that can communicate with base stations 106, 108, 114, and/or 116 in respective coverage areas 102, 104, 110, and 112. Base stations 106, 108, 114, and 116 can each be a macrocell, femtocell, picocell, or similar base station, relay node, mobile base station, a device communicating in peer-to-peer or ad-hoc mode, a portion thereof, and/or the like. Device 118 can be a UE, modem (or other tethered device), a portion thereof, and/or the like.

According to an example, device 118 can be within RAT1 coverage area 102 and can register with a related network by communicating with base station 106. Device 118 can be in idle-mode, such that base station 106 can transmit paging signals to device 118 to facilitate idle-mode camping. In addition, device 118 can store one or more parameters from base station 106 regarding RAT1 coverage area 102. Camping can generally refer to the ability of a device to receive paging signals from a base station transmitted at certain time intervals in a wireless network; in one example, the device can power off a transceiver during time periods during which paging signals are not expected to conserve power at the device. Thus, when a device is camping, a base station can send paging signals to the device to maintain a connection therewith, and the paging signals can also be used to notify the device to switch from idle-mode to active-mode to communicate with the base station (e.g., upon receiving a call, short message service (SMS), or other notification).

Device 118 can move to RAT2 coverage area 110 while in idle-mode, which can include performing idle-mode reselection from base station 106 to base station 114. Reselection can refer to determining to communicate with a target base station from a source base station based at least in part on measuring signals from the target base station and determining the target base stations is more suitable for communications. Such a determination can be based at least in part on the measuring, such as determining that signals from the target base station have a signal-to-noise ratio improved over a threshold level from the source base station. The determination can be made by the source base station, device, etc. In one example, the source base station can provide device information to the target base station and can instruct the device to receive signals from the target base station instead of (or in addition to, for soft reselection) the source base station.

During the reselection or otherwise, device 118 can receive one or more parameters regarding RAT2 coverage area 110 from base station 114, and can determine whether to perform registration with RAT1 through a network related to RAT2 via base station 114 based at least in part on the one or more parameters to update a registration status. For example, device 118 can register with RAT1 through the network related to RAT2 to receive one or more services specific to RAT1. Thus, if device 118 registers with RAT1 through base station 114, in one example, base station 114 can forward paging signals received from base station 106 to device 118. In some instances, the paging signals can cause device 118 to fallback to the network of RAT1 (or transmit other paging signals that cause the fallback) and communicate with base station 106, as described. In addition, it is to be appreciated, for example, that device 118 can perform registration for an initial entrance into a given coverage area to obtain registration parameters and cause the given base station to begin transmitting paging signals to the device 118. For example, the device 118 can be initialized in RAT1 coverage area 102, in which case device 118 can perform registration with the RAT1 network via base station 106, RAT2 coverage area 110, in which case device 118 can perform registration with the RAT2 network and RAT1 network via base station 114, etc. In any case, in the examples described herein, the device 118 can be determining whether to update a registration status with RAT1 can include determining whether to update the registration status through base station 114 upon returning to RAT2 coverage area 110, through base station 106 upon returning to RAT1 coverage 102, etc.

In this regard, device 118 can exit RAT2 coverage area 110 returning to RAT1 coverage area 102, and can similarly determine whether to register with the network related to RAT1 based at least in part on one or more parameters received regarding RAT1. Where device 118 determines not to register, device 118 can receive paging signals from base station 106, and base station 114 can still forward the paging signals resulting in unnecessary cross-domain paging, since device 118 may not use the paging signal from base station 114. In addition, however, frequent entering and exiting between RAT1 coverage area 102 and RAT2 coverage area 110 by device 118 (e.g., where device is near the edge of RAT2 coverage area 110) can cause frequent registrations on the network of RAT2 as well as RAT1 via corresponding base stations 106 and 114, which can be described generally as a ping-pong effect. In this regard, for example, a different parameter or value of the one or more parameters can be provided to device 118 by base station 106 and/or 114 that indicates to register based additionally in part on a timer to balance frequent registrations and unnecessary paging by RAT2. Thus, the timer can be initialized upon an initial move from RAT1 or RAT2 coverage areas 102 or 110 to the other. If the timer is not expired, the device 118 can refrain from registering when moving between coverage areas 102 and 110 based on the different parameter or value. If the timer is expired, then device 118 can register on the RAT in whichever coverage area 102 or 110 the device 118 is entering (e.g., and the timer can again be initialized), which can prevent the ping-pong effect described above.

Moreover, device 118 can move from RAT1 coverage area 102 to RAT1 coverage area 104. In this example, device 118 can receive one or more parameters regarding RAT1 coverage area 104 that can indicate whether or not to perform registration with RAT1. In addition, device 118 can move from RAT2 coverage area 110 to RAT2 coverage area 112. In this example, device 118 can receive one or more parameters regarding RAT2 coverage area 112 that can indicate whether or not to update a registration status with RAT1 by performing a RAT1 registration through base station 116. Moreover, in this example, it is to be appreciated that RAT2 coverage area 112 can be within RAT1 coverage area 104 instead. In these examples, registration can also be based at least in part on a timer. Thus, if the timer is expired upon entering RAT1 coverage area 104 or RAT2 coverage area 112, device 118 can register with the RAT1 network, as described.

In one specific example, RAT1 coverage areas 102 and 104 can be a circuit-switched coverage areas, such as CDMA2000 1x (1x), and base stations 106 and 108 can provide access to a corresponding network. Moreover, in this example, RAT2 coverage areas 110 and 112 can be LTE, and base stations 114 and 116 can provide access to a corresponding network. In this regard, device 118 in LTE coverage area 110 can have the ability perform a 1x registration for enabling circuit-switched fallback (CSFB) capability to handle voice communications, SMS, etc. It is to be appreciated that this can be accomplished using an S102 tunnel between the LTE and 1x networks (e.g., via base station 114). Thus, base station 114 in this example, can forward 1x paging signals to device 118—e.g., when device 118 is in idle-mode—to facilitate CSFB to 1x and communicating with base station 106. In this example, as described further herein, base stations 106, 108, 114, and 116 can advertise one or more predetermined registration tracking parameters in system information, which can include one or more overhead system messages such as system information blocks (SIB), system parameter messages (SPM), etc., depending on the RAT, and can utilize the predetermined registration tracking parameters to cause device 118 to perform 1x registrations or not, as described further herein.

In one example, the predetermined registration tracking parameter can be a band class parameter, a tracking area code, etc. It is to be appreciated that the predetermined registration tracking parameter is not so limited; rather these are examples of possible parameters, and the predetermined registration tracking parameter can be substantially any parameter that is, for example, predetermined for a network and/or device, and related to performing registrations. In addition, for example, the predetermined registration tracking parameter can be predetermined, which can relate to the parameter being pre-agreed upon between a network and a device. In examples described herein, the predetermined registration tracking parameter can have possible values pre-agreed upon between the network and device (e.g., retrievable from a device configuration, hardcoding, etc.) to indicate that the device should update a registration, as described further herein.

For example, the band class parameter can store a band class value in 1x, which can be an integer from 0-31 representing a function of the frequency a device, for example device 118, uses to communicate with a cellular system (e.g., with a base station of the cellular system). For instance, band class 0 (BC0) can correspond to the frequencies in the 800 megahertz (MHz) band. The band class of operation, for example, can be determined based at least in part on a frequency of operation of the device operating in the 1x network, and stored as part of a device registration context. Since the 1x band class is not known while operating over LTE, the band class to be stored as part of 1x registration context created over the 5102 LTE tunnel for CSFB is not known. Thus, a band class parameter can be added to the parameters sent over LTE by base stations 114 and 116 to allow device 202 to learn the 1x band class. In this regard, for example, a band class parameter can be received from system 100 via any of the base station, 106, 108, 114 or 116.

Moreover, for example, certain other parameters advertised in the SIB, SPM, etc. can additionally or alternatively affect registration behavior at device 118, such as system identifier (SID)/network identifier (NID), a number of total registration zones, a multiple NID indicator, a multiple SID indicator, a power-up registration indicator, a power-down registration indicator, a band class, and/or the like. In an example, 1x base stations 106 and 108 can specify a different NID in SPM than LTE base stations 114 and 116 in SIB, and/or contiguous LTE cells or coverage areas and use the same NID. Base stations 106, 108, 114, and 116 can specify a number of total registration zones greater than zero to avoid repeated registrations by device 118 when moving between the same 1x coverage areas or LTE coverage areas 110 and 112 (which can also be referred to as 1x pre-registration coverage areas). In addition, for example, base stations 106, 108, 114, and 116 can set the multiple NIDs indicator to zero to cause device 118 to register when moving across LTE-1x coverage areas. In another example, base stations 106, 108, 114, and 116 can set power-up registration indicator to 1 to cause power-up registrations. It should be noted that other parameters can be used in lieu of the band class parameter. The following embodiment described below illustrates the use of another parameter.

In this embodiment, RAT1 coverage areas 102 and 104 can be GSM and/or UMTS coverage areas, and thus base stations 106 and 108 can be GSM and/or UMTS base stations. In this regard, as described, device 118 in LTE coverage area 110 can have the ability perform a GSM or UMTS registration over the LTE network for handling voice communications, SMS, etc. in CSFB. It is to be appreciated that this can be accomplished using one or more tunnels (e.g., an SGs tunnel) between the LTE and GSM or UMTS networks (e.g., via base station 114). Thus, base station 114 in this example, can forward GSM or UMTS paging signals to device 118—e.g., when device 118 is in idle-mode—to facilitate communicating with base station 106. In this example, as described further herein, base stations 106, 108, 114, and 116 can advertise tracking area code values, which can be utilized to cause device 118 to update a GSM or UMTS registration status or not, as described further herein.

For example, device 118 can receive a tracking area list upon performing a GSM or UMTS registration with base station 106 or 108 (and/or over an LTE connection with base station 114 or 116). The tracking area list can define a set of tracking areas for which a device need not update a registration status. Thus, where the device moves from one GSM or UMTS coverage area to another, if the new GSM or UMTS coverage area broadcasts a tracking area code (e.g., as a value of a tracking area code parameter in an system information) that is in the tracking area list, the device need not update a registration status. It is to be appreciated that the determination of whether to update the registration status can be further based on a periodic registration timer, as described further herein. Since the tracking area code is not known while operating over LTE, a tracking area code for the GSM or UMTS registration context created over the tunnel is not known. Thus, a tracking area code can be added to the parameters sent over LTE by base stations 114 and 116. The tracking area codes can be specified to control whether device 118 performs a GSM or UMTS registration when moving between coverage areas of LTE with GSM or UMTS and GSM or UMTS with no LTE coverage, as described further herein.

Though described generally in terms of RAT2 coverage areas within RAT1 coverage areas and performing RAT1 registration over a RAT2 network, it is to be appreciated that RAT2 coverage can expand to encompass RAT1 coverage areas (e.g., coverage areas 102 and 104 can be RAT2 coverage areas, and coverage areas 110 and 112 can be RAT1 coverage areas). In this example, it is to be appreciated that device 118 can still perform RAT1 registrations over the RAT2 coverage areas that encompass the RAT1 coverage areas. In the specific examples above, for example, it is to be appreciated that coverage areas 102 and 104 and base stations 106 and 108 can be LTE, while coverage areas 110 and 112 and base stations 114 and 116 can be 1x, GSM, or UMTS.

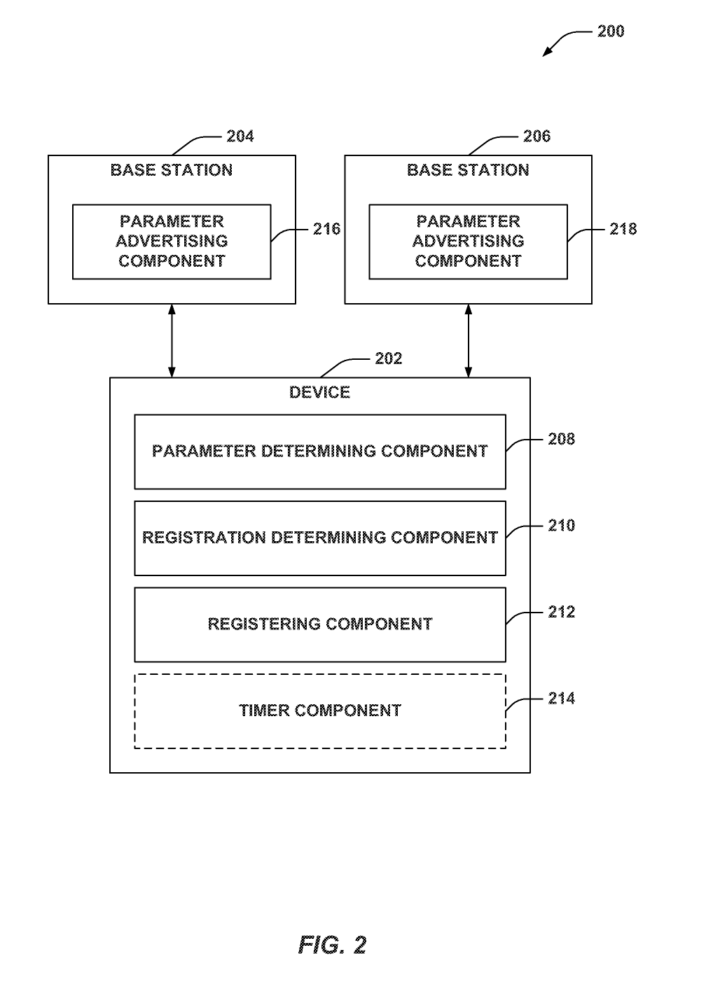

Turning to FIG. 2, an example wireless communication system 200 is illustrated that facilitates determining whether to perform a registration for a RAT through a network of a different RAT. System 200 includes a device 202 that can communicate with base stations 204 and/or 206 to receive access to one or more wireless networks. For example, device 202 can be within coverage of base stations 204 and/or 206, as described. Device 202 can be a UE, modem, etc., and base stations 204 and 206 can each be a femtocell, macrocell, or picocell base station, etc., as described above.

Device 202 can include a parameter determining component 208 for determining one or more parameters related to performing a registration with one or more base stations, and a registration determining component 210 for discerning whether to update a registration status by performing a registration based at least in part on the one or more parameters. Device 202 can additionally include a registering component 212 for registering with the one or more base stations based at least in part on the determination, and an optional timer component 214 for managing a timer associated with determining whether to register with the one or more base stations. Base stations 204 and 206 can each include a parameter advertising component 216 and 218 for broadcasting system information in a wireless network.

According to an example, device 202 can communicate with base station 204 using a RAT to receive access to a wireless network. Device 202 can also be within a coverage area of base station 206, which can operate using a different RAT in this example. Moreover, as described, device 202 can register with the different RAT through base station 204 for receiving one or more services related to the different RAT. Device 202 can move between areas that are covered by base station 204 and 206 and areas that are covered only by base station 206, which can cause reselection of base stations 204 and 206, and registration determining component 210 can determine whether to register with the different RAT through base station 204 (e.g., to update a registration status with the different RAT) and/or 206 each time device 202 moves into one of the areas (e.g., and/or performs reselection).

For example, parameter advertising components 216 and 218 can indicate one or more parameter values in system information advertised by base stations 204 and 206 for specifying whether to perform a registration at a device when moving to a base station of a different RAT. For example, as described, the one or more parameter values can relate to predetermined registration tracking parameters. Parameter determining component 208 can determine the one or more parameters (e.g., based on obtaining the one or more parameters in the system information, determining the one or more parameters from one or more other parameters, etc.), and registration determining component 210 can decide whether to perform a registration with base station 204 or 206 upon entering a coverage area thereof based at least in part on the one or more parameters. Where registration determining component 210 determines to perform the registration, registering component 212 can perform the registration, update a registration status, and/or the like. This can prevent unnecessary signals from base station 204 and/or 206, whichever one is no longer communicating with device 202.

In another example, parameter advertising component 216 and/or 218 can indicate a parameter value that relates to consulting a timer to further determine whether to perform registration. In this example, timer component 214 can initialize a timer upon leaving coverage area of base station 204 and/or 206. Parameter determining component 208 can determine or otherwise obtain the parameter in system information, and registration determining component 210 can determine whether the timer at timer component 214 has expired in determining whether to register with base station 204 and/or 206. In one example, where the timer has not expired, registering component 212 can register with base station 204 and/or 206 upon expiration of the timer (e.g., which can be indicated to registering component 212 by timer component 214, determined by registering component 212, and/or the like). This can prevent frequent registration. In addition, timer component 214 can again initialize the timer upon registering and/or upon device 202 leaving the current coverage area.

According to another example, base stations 204 and 206 can operate using the same RAT. In this example, parameter advertising components 216 and 218 can indicate the same one or more parameters in system information. Thus, parameter determining component 208 can determine the one or more parameters, and registration determining component 210 can determine not to perform a registration upon moving between base stations 204 and 206, and/or whether to register based at least in part on timer component 214 since the one or more parameters are the same. As described, for example, timer component 214 can initialize the timer upon device 202 leaving coverage of base station 204 and/or 206. This can prevent frequent registration while ensuring device 202 occasionally updates registration where such functionality is desired.

In a specific example, base station 204 can be an LTE base station, and base station 206 can be a 1x base station. Thus, as described, device 202 can perform 1x registration with base station 204 to utilize the 1x network for one or more services, such as voice communications, SMS, etc. Thus, for example, device 202 can move between base stations 204 and 206, which can include moving into an LTE coverage area for base station 204 from a coverage area for base station 206 with no LTE coverage, and/or vice versa, in idle-mode. For example, device 202 can perform idle-mode reselection among base stations 204 and/or 206. In this example, registration determining component 210 can determine whether to perform 1x registrations (e.g., to update a registration status with an LTE network or the 1x network) with a corresponding base station 204 or 206 upon moving. In an example, parameter advertising components 216 and/or 218 can utilize a value of a band class parameter in system information to control whether device 202 updates a registration status when moving between the areas of LTE and 1x coverage and the areas of 1x with no LTE coverage. Moreover, for example, the 1x registration can relate to a power-up registration.

In one example, it can be desired to cause device 202 to update a registration status by performing a 1x registration when moving from 1x only coverage to LTE and 1x coverage and/or vice versa to mitigate unnecessary signaling from base station 204 when device 202 is communicating with base station 206 in a 1x only coverage area. Moreover, for example, switching between base stations advertising different values of band class parameters can cause device 202 to update a registration with the base station to which device 202 is moving. In this example, parameter advertising component 216 can indicate a value of a band class parameter of LTE base station 204 (e.g., in a SIB) to be a band class not used by base station 206 or any base stations in the 1x network. This information can be known by a service provider of the 1x and LTE networks and accordingly provisioned to base station 204. Thus, parameter determining component 208 can determine or otherwise obtain the value of the band class parameter of base station 204 from parameter advertising component 216 when communicating with base station 204 and/or evaluating base station 204 for reselection when device 202 is in a related coverage area.

In this example, registration determining component 210 can decide to perform a 1x registration with base station 204 and/or 206 (e.g., upon device 202 determining to be served by base station 204 and/or 206) based at least in part on comparing differing values for band class parameters received from base stations 204 and 206. In one example, where device 202 is communicating with base station 204 and reselecting to base station 206, parameter determining component 208 can have previously received and stored the value of the band class parameter for base station 204 (e.g., as part of initially communicating therewith, reselecting to base station 204, etc.) in system information, and can determine the value of the band class parameter for base station 206 based at least in part on an operating frequency for communicating with base station 206 (e.g., which can be part of system information communicated by parameter advertising component 218). In this example, registration determining component 210 can compare the band class values and determine a difference in the values, and registering component 212 can thus perform 1x registration with base station 206 based on the difference.

Similarly, where device 202 is communicating with base station 206 and moving to base station 204, parameter determining component 208 can have previously determined a value of the band class parameter for base station 206 (e.g., based at least in part on an operating frequency used to communicate with base station 206), and parameter determining component 208 can additionally receive a value of the band class parameter for base station 204 as part of reselecting thereto. Registration determining component 210 can similarly determine a difference in band class values, and registering component 212 can accordingly perform a 1x registration with LTE base station 204 (e.g., via S102 tunnel) after reselecting thereto to receive 1x paging signals. It is to be appreciated that registering component 212 can store the band class value as part of registration for subsequent use by registration determining component 210.

In another example, parameter advertising component 216 can indicate a wildcard band class value in system information that indicates to perform 1x registration based on a timer value to prevent a ping-pong effect caused by frequent registrations, as described. For instance, the wildcard band class value can be 31, where the band class parameter corresponds to an integer value between 0-31, or substantially any value that can be defined and utilized by base stations 204 and/or 206 as well as device 202 to indicate the behavior described below. In this example, parameter determining component 208 can obtain the value of the band class parameter in system information from base station 204 (e.g., as part of communicating therewith or when evaluating the base station 204 for reselection, as described). In either case, registration determining component 210 can determine to perform 1x registration with base station 204 or base station 206 (e.g., depending on which one device 202 is moving to) based at least in part on a timer managed by timer component 214. In this example, timer component 214 can initialize the timer after initially moving from base station 204 and/or 206.

In one example, the timer can correspond to specifically moving between base station 204 and 206 or generally moving between base stations of different RATs, such that the timer is initialized and runs while device is within the coverage area of base station 204 and/or 206. In this example, if device 202 enters a coverage area of a different base station, timer component 214 can cancel the timer and/or initialize a timer related to the different base station. For example, the timer value can be set to substantially any period of time (e.g., a number of days, hours, minutes, seconds, etc.) that can be optimized to balance conserving resources used by unnecessary paging signals and mitigating frequent registrations, as described. In any case, registration determining component 210 determines the value of the band class parameter of base station 204 is the wildcard band class value, registration determining component 210 can receive the timer from timer component 214 and determine whether the timer is expired in determining whether or not to perform 1x registration. In one example, where the timer is not expired, once the timer does expire, registration determining component 210 can be notified (e.g., by timer component 214), and registration determining component 210 can determine to perform 1x registration with a current base station. In addition, in this example, timer component 214 can reinitialize the timer as part of registering component 212 performing the 1x registration, device 202 leaving coverage of base station 204 or 206, and/or the like. In any case, registering component 212 can perform the 1x registration with a base station where so determined.

In another example, parameter advertising component 216 can indicate a no-match band class value in system information that indicates to perform 1x registration. Again, this can be substantially any value of the band class parameter that is defined and utilized by base stations 204 and/or 206, as well as device 202, to indicate to perform 1x registration. In this example, parameter determining component 208 can obtain the value of the band class parameter in system information from base station 204 (e.g., as part of communicating therewith or when evaluating the base station 204 for reselection, as described). Registration determining component 210 can determine to perform 1x registration with base station 204 based on determining that the band class is the no-match band class value for forcing registration.

Moreover, as described previously, it is to be appreciated in the above examples that device 202 has initially performed a registration with base station 204 and 206, and registration determining component 210 is determining whether to update a registration status by reregistering in the above examples to control whether base stations 204 and/or 206 transmit paging signals for device 202. Furthermore, in an example, the base stations 204 and 206 can both be 1x base stations or can both be LTE base stations. In this example, parameter advertising components 216 and 218 can advertise the same or similar band class parameter value, and thus registration determining component 210 can determine not to perform 1x registration when moving between base stations 204 and 206 based on encountering the same or similar values. In another example, registration determining component 210 can analyze a different timer at timer component 214 as part of determining same or similar band class of base stations 204 and 206 or otherwise determining not to update a registration status. For example, timer component 214 can initialize the different timer as part of initially moving from base station 204 and/or 206, etc., as described. In one example, this can be a periodic registration time or timer, as described herein.

In yet another example, parameter advertising components 216 and 218 can indicate a multiple NIDs parameter as zero, and can advertise a NID. For example, the NID can relate to a RAT, such that where base stations 204 and 206 area of different RATs, or where a new registration is otherwise desired for device 202, parameter advertising components 216 and 218 can advertise different NIDs. In this example, registration determining component 210 can store a SID/NID list related to SID/NIDs in which device 202 has registered. Where the parameter determining component 208 encounters a multiple NID parameter, registration determining component 210 can set the list size to the multiple NID parameter and can delete a portion of the SID/NIDs where the multiple NID parameter is less than a current list size. Where the multiple NID parameter is zero, registration determining component 210 can store a most recent NID. Thus, where device 202 moves between base stations 204 and 206, if NID advertised by the corresponding parameter advertising component 216 or 218 does not match the NID stored by registration determining component 210 (e.g., a NID of a current base station 204 or 206), registration determining component 210 can determine to perform a 1x registration with the base station 204 or 206 to which device 202 moves, and registering component 212 can thus perform the 1x registration. If the advertised NID is the same, device 202 can refrain from performing the 1x registration, and/or can do so according to a timer at timer component 214, as described above.

According to another example, parameter determining component 208 can obtain a periodic registration time by which registering component 212 can register with a RAT to maintain a registration status therewith. This can be regardless of whether device 202 is camped on base station 204 or 206, which can utilize different RATs. In addition, parameter determining component 208 can obtain an active-mode registration time, which can be utilized for performing a registration with the RAT when device 202 moves to an active communication mode (e.g., for another purpose). For example, parameter determining component 208 can obtain the parameter from a hardcoding, configuration, from one or more of base stations 204 and/or 206, etc. Thus, for example, registration determining component 210 can detect device 202 switching from idle-mode to active-mode, whether communicating with base station 204 or 206. This can be based at least in part on receiving, monitoring, or detecting one or more events (such as one or more messages received from or transmitted to base station 204 and/or 206, for example). In this example, registration determining component 210 can evaluate the active-mode registration time to determine whether to perform a registration with the RAT (e.g., based on communicating with a base station of the RAT or through a base station of a different RAT, as described), and registering component 212 can perform the registration based on the determination.

For example, the active-mode registration time can define a difference in time between a current time and the periodic registration time. Thus, for example, where the difference between the current time and periodic registration time is less than the active-mode registration time, registration determining component 210 can determine to update a registration status with the RAT, and registering component 212 can update the registration status. It is to be appreciated that registering component 212 can update the registration status regardless of whether device 202 is communicating with a base station of the RAT or a different RAT. For example, registering component 212 can perform a RAT registration using base station 204 or 206, whichever device 202 is communicating with in active-mode. In another example, timer component 214 can initialize a periodic registration timer as part of registering, where expiration of the periodic registration timer causes registering component 212 to register with the RAT. In this example, registration determining component 210 can determine whether the active-mode registration time is less than or equal to the periodic registration timer value to determine whether to update the registration status with the RAT. Moreover, for example, an active-mode registration timer initialized by timer component 214 can be used in the alternative. In this example, the active-mode registration timer can similarly be initialized as part of registering, and registration determining component 210 can determine whether the active-mode registration timer has expired to determine whether to update a registration status when subsequently switching from idle-mode to active-mode communications.

In another example, base station 206 can be a GSM or UMTS base station. Thus, as described, device 202 can perform GSM or UMTS registration with base station 204 to utilize the GSM or UMTS network for one or more services, such as voice communications, SMS, etc. Thus, for example, device 202 can reselect between base stations 204 and 206. In this example, registration determining component 210 can determine whether to perform GSM or UMTS registrations (e.g., to update a registration status with an LTE network or the GSM or UMTS network) with a corresponding base station 204 or 206 as part of reselecting. In an example, parameter advertising components 216 and/or 218 can utilize a value of a tracking area code parameter in system information to control whether device 202 updates a registration status when moving between the areas of LTE and GSM or UMTS coverage, and the areas of GSM or UMTS with no LTE coverage.

For example, parameter advertising component 216 can indicate a wildcard tracking area code value in system information that indicates to not update a GSM or UMTS registration status. Parameter determining component 208 can determine or otherwise obtain the tracking area code value from base station 204 system information. Registration determining component 210 can determine the tracking area code value for base station 204 is the wildcard tracking area code value, and can determine not to update a GSM or UMTS registration status. As described, however, this can be subject to a periodic registration time or timer at timer component 214, as described above, such that expiration of the timer can cause registration with base station 204 though the wildcard tracking area code value is broadcast by parameter advertising component 216. In addition, for example, timer component 214 can initialize a different timer value to prevent the ping-pong effect, described above, and registration determining component 210 can further determine whether to update the registration status based at least in part on the different timer.

In another example, where the tracking area code value is not the wildcard tracking area code value, registration determining component 210 can discern whether to update a GSM or UMTS registration (e.g., via SGs tunnel) based at least in part on determining whether the tracking area code value is in a tracking area list received upon performing an initial GSM or UMTS registration with base station 204 and/or 206. In addition, it is to be appreciated that when moving from base station 204 to base station 206, parameter determining component 208 can determine or otherwise obtain the tracking area code value from base station 206, and registration determining component 210 can determine whether to update a registration status based at least in part on whether the tracking area code value is in a tracking area list.

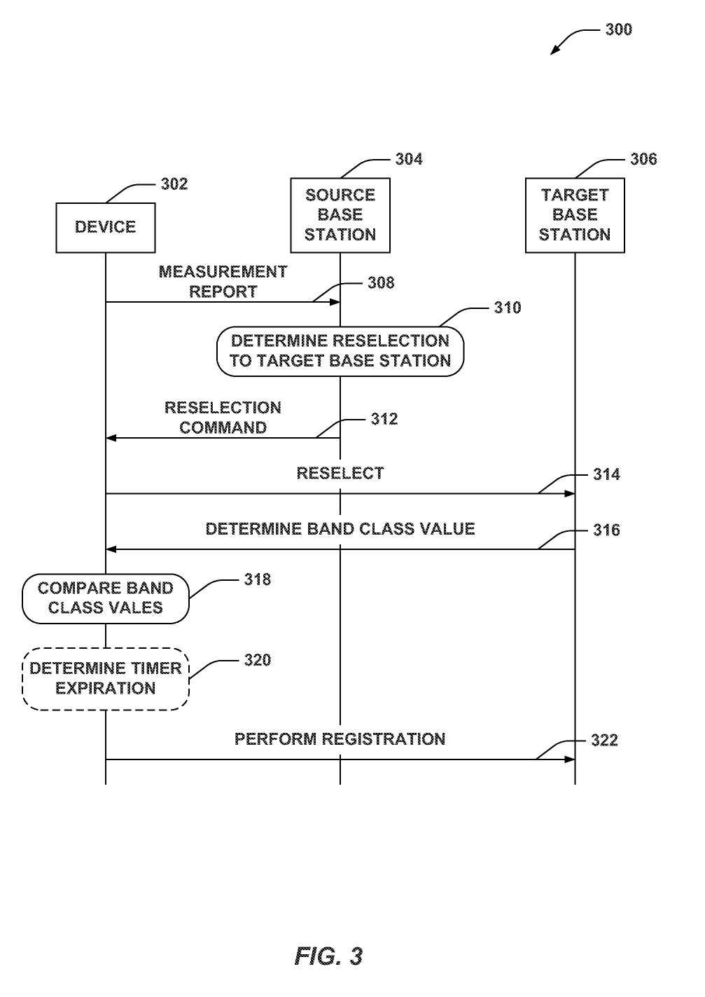

Referring to FIG. 3, illustrated is an example wireless communication system 300 that facilitates performing registration based at least in part on comparing band class values of multiple base stations. System 300 can include a device 302 that communicates with a source base station 304 and/or a target base station 306 to receive access to a wireless network. As described, device 302 can be a UE, modem, etc., and source base station 304 and target base station 306 can each be a macrocell, femtocell, picocell, or similar base station, relay node, etc. In addition, in one example, source base station 304 can be a 1x base station and target base station 306 can be an LTE base station and/or vice versa.

According to an example, device 302 can communicate with source base station 304 in idle-mode, and can transmit a measurement report 308 thereto to facilitate idle-mode reselection. Source base station 304 can determine that target base station 306 is more desirable for serving device 302 based at least in part on the measurement report. Thus, source base station 304 can transmit a reselection command to device 302 to instruct the device 302 to utilize the target base station 306 to access a wireless network. It is to be appreciated that source base station 304 can engage in additional communications to facilitate reselection, such as communicating device 302 context information to target base station 306, etc. Device 302 can reselect 314 to target base station 306, which can include establishing a connection therewith, and/or the like. In addition, device 302 can determine a band class 316 of target base station 306. This can include, for example, receiving system information from target base station 306 (e.g., SIB, SPM, etc.) and determining a value of the band class from one or more parameters thereof. Further, determining the band class value can be based at least in part on the operating frequency of target base station 306, and/or the like. Device 302 can compare band class values 318 of source base station 304 and target base station 306.

For example, as described, device 302 can have obtained or determined the value of the band class parameter of source base station 304 from previously communicating therewith, (e.g., in system information, based on an operating frequency, etc.). In this example, band class values of source base station 304 and target base station 306 can be different. In one example, the band class value of source base station 304 or target base station 306 can be a wildcard band class value, and device 302 can optionally determine a timer expiration 320, which can indicate to perform registration. Device 302 can, in either case, perform registration 322 with target base station 306 based at least in part on differing band class values and/or the combination of the wildcard band class and expiring timer, as described above. The registration, in one example, can be a 1x registration performed with target base station 306 as an LTE or 1x base station, as described.

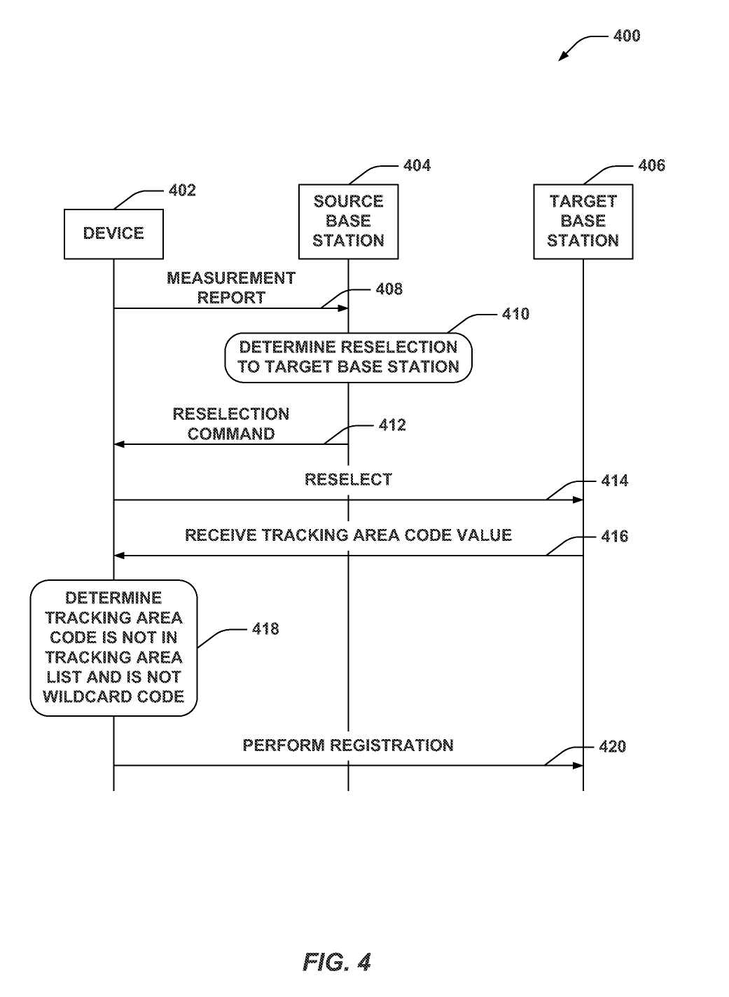

Referring to FIG. 4, illustrated is an example wireless communication system 400 that facilitates performing registration based at least in part on evaluating a tracking area code. System 400 can include a device 402 that communicates with a source base station 404 and/or a target base station 406 to receive access to a wireless network. As described, device 402 can be a UE, modem, etc., and source base station 404 and target base station 406 can each be a macrocell, femtocell, picocell, or similar base station, relay node, etc. In addition, in one example, source base station 404 can be a GSM or UMTS base station and target base station 406 can be an LTE base station and/or vice versa.

According to an example, device 402 can communicate with source base station 404 in idle-mode, and can transmit a measurement report 408 thereto to facilitate idle-mode reselection. Source base station 404 can determine that target base station 406 is more desirable for serving device 402 based at least in part on the measurement report. Thus, source base station 404 can transmit a reselection command to device 402 to instruct the device 402 to utilize the target base station 406 to access a wireless network. It is to be appreciated that source base station 404 can engage in additional communications to facilitate reselection, such as communicating device 402 context information to target base station 406, etc. Device 402 can reselect 414 to target base station 406, which can include establishing a connection therewith, and/or the like. In addition, device 402 can receive a tracking area code value 416 of target base station 406. This can include, for example, receiving system information from target base station 406 (e.g., SIB, SPM, etc.), and determining a value of the tracking area code from one or more parameters thereof. Device 402 can determine that the tracking area code value is not in a tracking area list and is not a wildcard tracking area code 418, and can accordingly perform registration 420 (e.g., a GSM or UMTS registration) with target base station 406.

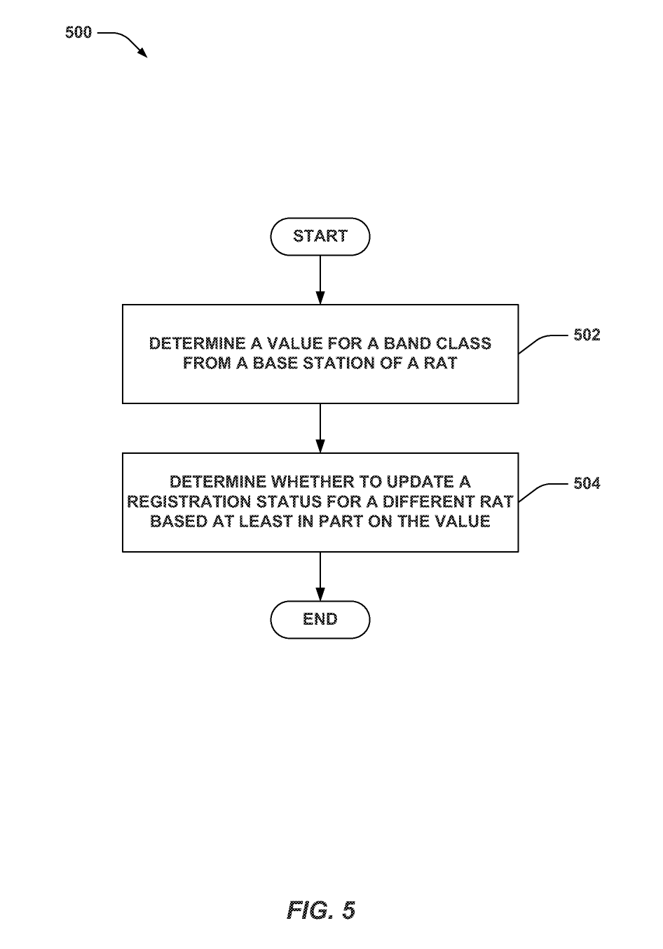

Referring to FIGS. 5-8, example methodologies relating to determining whether to perform registration on one or more networks are illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, it is to be appreciated that a methodology could alternatively be represented as a series of interrelated states or events, such as in a state diagram. Moreover, not all illustrated acts may be required to implement a methodology in accordance with one or more embodiments.

Referring to FIG. 5, an example methodology 500 is displayed that facilitates determining whether to perform registration on a network of a RAT. At 502, a value for a band class can be received from a base station of a RAT. As described, for example, the value can be received in system information (e.g., SIB, SPM, etc.) as one or more parameters from the base station, determined based at least in part on an operating frequency for communicating with the base station, etc. In addition, for example, the base station can be a serving or target base station. At 504, it can be determined whether to update a registration status for a different RAT based at least in part on the value. As described, where different band class values are encountered for the RAT and different RAT, a registration can be performed on the different RAT using one or more base stations (e.g., of the RAT or different RAT), which can include the base station from which the band class parameter value is received or one or more other base stations. As described, a service provider of the base station(s) can so configure band class values to cause registration in some cases. Moreover, additional parameters can be evaluated in determining whether to perform a registration, such as a value or expiration related to one or more timers.

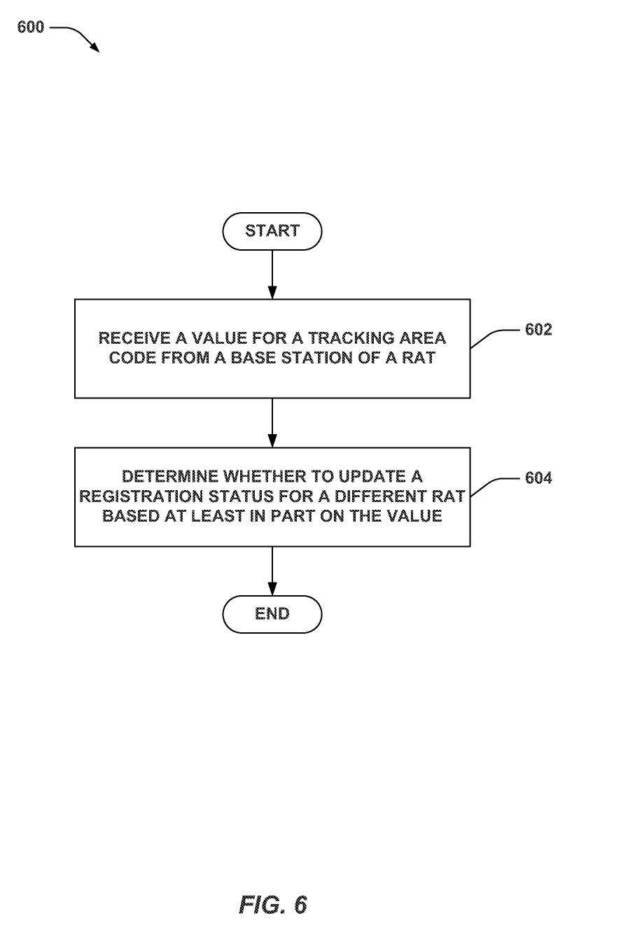

FIG. 6 illustrates an example methodology 600 that facilitates determining whether to perform registration on a network of a RAT. At 602, a value for a tracking area code can be received from a base station of a RAT. As described, for example, the value can be received in system information (e.g., SIB, SPM, etc.) as one or more parameters from the base station, etc. In addition, for example, the base station can be a serving or target base station. At 504, it can be determined whether to update a registration status for a different RAT based at least in part on the value. As described, where a wildcard tracking area code is received, it can be determined not to update a registration status. Where other tracking area codes are received, the determining whether to update the registration status can be further based on whether the tracking area codes are in a received tracking area list, as described. As described, a service provider of the base station(s) can so configure tracking area values to cause registration in some cases. Moreover, additional parameters can be evaluated in determining whether to perform a registration, such as a value or expiration related to one or more timers.

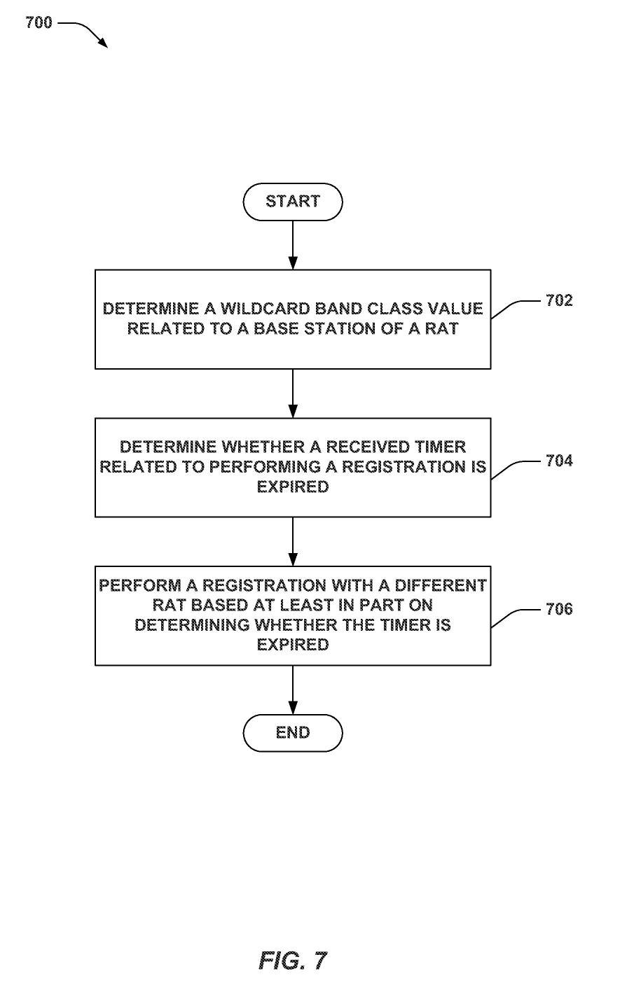

Turning to FIG. 7, an example methodology 700 is displayed that facilitates performing a registration over a RAT based at least in part on a band class value and a timer. At 702, a wildcard band class value can be determined related to a base station of a RAT. For example, as described, the base station can indicate the band class value in system information. In addition, the system information can be analyzed upon connecting to the base station for communicating therewith. At 704 it can be determined whether a received timer related to performing a registration is expired. For example, this can be determined based at least in part on detecting the wildcard band class value of the base station upon determining to transfer communications to/from the base station, as described. At 706, a registration can be performed with a different RAT based at least in part on determining whether the timer is expired. For example, where the timer has not expired, registration is not performed to prevent a ping-effect, as described. Otherwise, the registration can be performed to cause one or more base stations to cease transmitting paging signals.

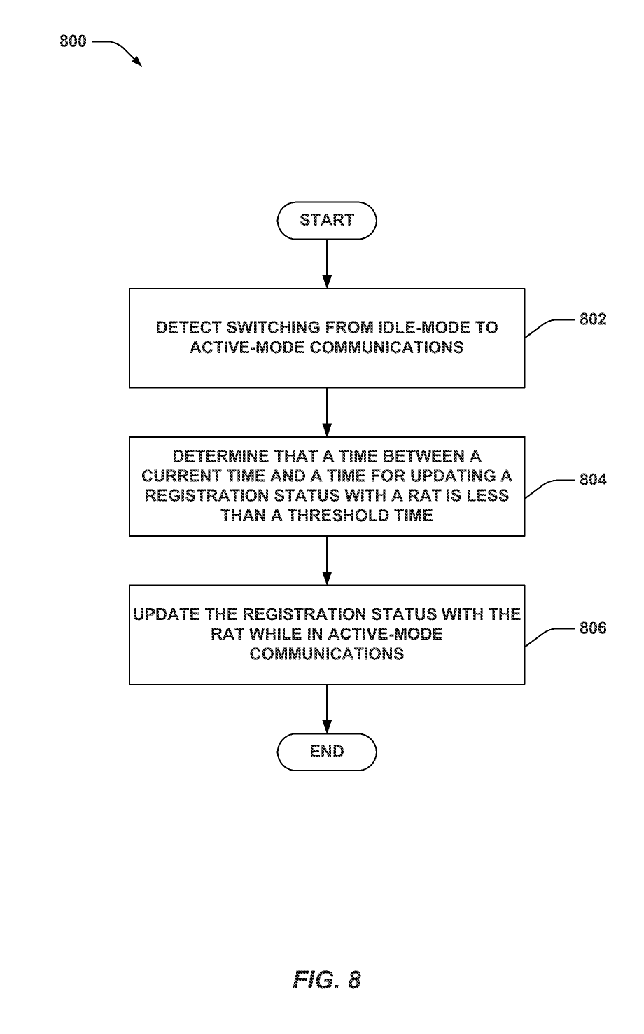

Referring to FIG. 8, an example methodology 800 is displayed that facilitates determining whether to update a registration status while communicating in active-mode. At 802, switching from idle-mode to active-mode communications can be detected. This can be based at least in part on one or more received, monitored, or detected events, such as receiving or sending one or more messages to a corresponding base station, and/or the like. At 804, it can be determined that a time between a current time and a time for updating a registration status with a RAT is less than a threshold time. For example, the threshold time can relate to an active-mode registration time, and the time for updating the registration status can include a periodic registration time, as described above. At 806, the registration status can be updated with the RAT while in active-mode communications. This can be based on determining that the time between a current time and a time for updating the registration status is less than the threshold time, as described. In addition, a periodic registration timer and/or an active-mode registration timer can be similarly utilized to determine to update the registration status, as described above.

It will be appreciated that, in accordance with one or more aspects described herein, inferences can be made regarding determining whether to request registration over one or more RATs, determining a band class from an operating frequency, and/or the like, as described. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

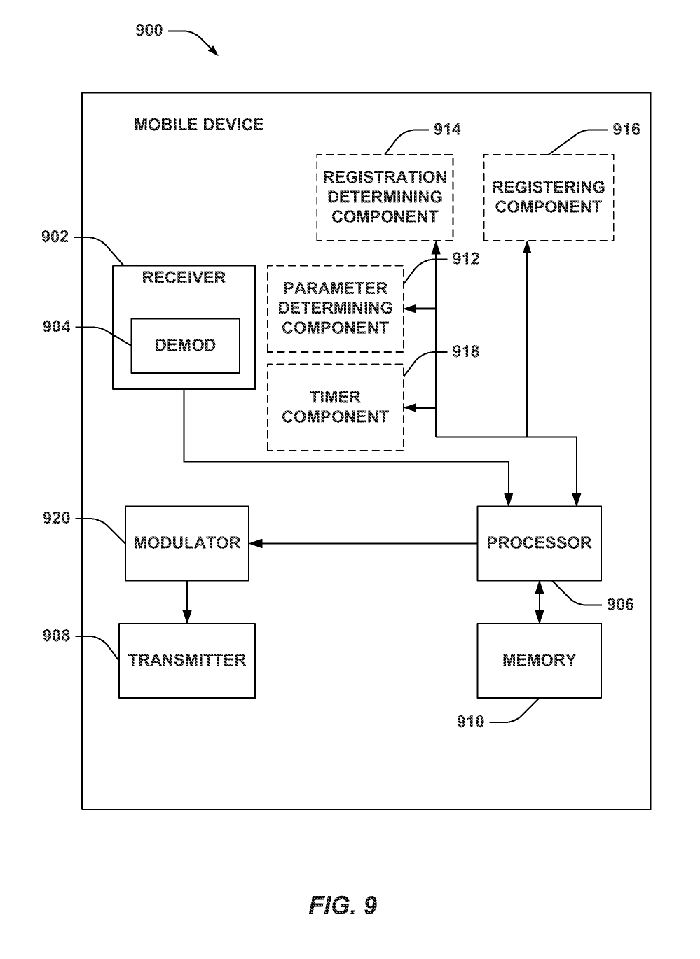

FIG. 9 is an illustration of a mobile device 900 that facilitates determining whether to perform a registration with one or more RATs based on receiving one or more parameters thereof. Mobile device 900 comprises a receiver 902 that receives a signal from, for instance, a receive antenna (not shown), performs typical actions on (e.g., filters, amplifies, downconverts, etc.) the received signal, and digitizes the conditioned signal to obtain samples. Receiver 902 can comprise a demodulator 904 that can demodulate received symbols and provide them to a processor 906 for channel estimation. Processor 906 can be a processor dedicated to analyzing information received by receiver 902 and/or generating information for transmission by a transmitter 908, a processor that controls one or more components of mobile device 900, and/or a processor that both analyzes information received by receiver 902, generates information for transmission by transmitter 908, and controls one or more components of mobile device 900.

Mobile device 900 can additionally comprise memory 910 that is operatively coupled to processor 906 and that can store data to be transmitted, received data, information related to available channels, data associated with analyzed signal and/or interference strength, information related to an assigned channel, power, rate, or the like, and any other suitable information for estimating a channel and communicating via the channel. Memory 910 can additionally store protocols and/or algorithms associated with estimating and/or utilizing a channel (e.g., performance based, capacity based, etc.).

It will be appreciated that the data store (e.g., memory 910) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 910 of the subject systems and methods is intended to comprise, without being limited to, these and any other suitable types of memory.

Processor 906 can further be optionally operatively coupled to a parameter determining component 912, which can be similar to parameter determining component 208, and a registration determining component 914, which can be similar to registration determining component 210. Processor 906 can also be optionally operatively coupled to a registering component 916, which can be similar to registering component 212, and a timer component 918, which can be similar to timer component 214. Mobile device 900 still further comprises a modulator 920 that modulate signals for transmission by transmitter 908 to, for instance, a base station, another mobile device, etc. Although depicted as being separate from the processor 906, it is to be appreciated that the parameter determining component 912, registration determining component 914, registering component 916, timer component 918, demodulator 904, and/or modulator 920 can be part of the processor 906 or multiple processors (not shown). In another example, parameter determining component 912, registration determining component 914, registering component 916, and/or timer component 918 can be components stored in memory 910 and/or executed (by processor 906) according to instructions stored in memory 910.

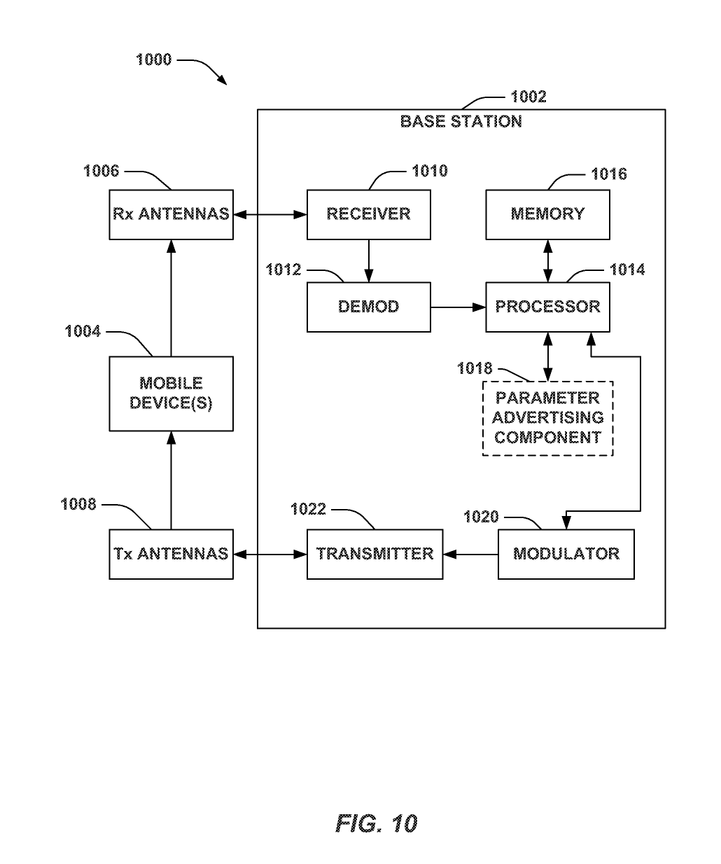

FIG. 10 is an illustration of a system 1000 that facilitates indicating one or more parameters to facilitate determining whether to perform a registration. System 1000 comprises a base station 1002, which can be substantially any base station (e.g., a small base station, such as a femtocell, picocell, etc., relay node, mobile base station . . . ) having a receiver 1010 that receives signal(s) from one or more mobile devices 1004 through a plurality of receive antennas 1006 (e.g., which can be of multiple network technologies, as described), and a transmitter 1022 that transmits to the one or more mobile devices 1004 through a plurality of transmit antennas 1008 (e.g., which can be of multiple network technologies, as described). In addition, in one example, transmitter 1022 can transmit to the mobile devices 1004 over a wired front link. Receiver 1010 can receive information from one or more receive antennas 1006 and is operatively associated with a demodulator 1012 that demodulates received information. In addition, in an example, receiver 1010 can receive from a wired backhaul link. Demodulated symbols are analyzed by a processor 1014 that can be similar to the processor described above with regard to FIG. 9, and which is coupled to a memory 1016 that stores information related to estimating a signal (e.g., pilot) strength and/or interference strength, data to be transmitted to or received from mobile device(s) 1004 (or a disparate base station (not shown)), and/or any other suitable information related to performing the various actions and functions set forth herein.

Processor 1014 is further optionally coupled to a parameter advertising component 1018, which can be similar to parameter advertising component 216 and/or 218. Moreover, for example, processor 1014 can modulate signals to be transmitted using modulator 1020, and transmit modulated signals using transmitter 1022. Transmitter 1022 can transmit signals to mobile devices 1004 over Tx antennas 1008. Furthermore, although depicted as being separate from the processor 1014, it is to be appreciated that the parameter advertising component 1018, demodulator 1012, and/or modulator 1020 can be part of the processor 1014 or multiple processors (not shown). In another example, parameter advertising component 1018 can be components stored in memory 1016 and/or executed (by processor 1014) according to instructions stored in memory 1016.

The various illustrative logics, logical blocks, modules, components, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal.

In one or more aspects, the functions, methods, or algorithms described may be implemented in hardware, software, firmware, or any combination thereof. If implemented in software, the functions may be stored or transmitted as one or more instructions or code on a computer-readable medium, which may be incorporated into a computer program product. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, substantially any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method operable by a device in wireless communications, comprising:
determining a value for a predetermined registration tracking parameter from a base station of a first radio access technology; and
determining whether to update a registration status for a second radio access technology based at least in part on the value for the predetermined registration tracking parameter.

2. The method of claim 1, wherein the predetermined registration tracking parameter is a band class.

3. The method of claim 2, further comprising updating the registration status for the second radio access technology, wherein the determining whether to update the registration status comprises determining to update the registration status based at least in part on determining that the value is different from a band class parameter value of the second radio access technology.

4. The method of claim 2, further comprising receiving a timer related to updating the registration status where the value indicates a wildcard band class, wherein the determining whether to update the registration status is further based at least in part on the timer.

5. The method of claim 4, wherein the determining whether to update the registration status comprises determining to not update the registration status based at least in part on determining that the value is the wildcard band class and determining that the timer is expired.

6. The method of claim 2, wherein the determining whether to update the registration status comprises determining to update the registration status based at least in part on determining that the value is a no-match band class.

7. The method of claim 2, wherein the determining the value for the band class comprises receiving the value for the band class from the base station.

8. The method of claim 2, wherein the determining the value for the band class comprises determining the value for the band class based at least in part on an operating frequency for communicating with the base station.

9. The method of claim 2, wherein the first radio access technology is third generation partnership project long term evolution and the second radio access technology is code division multiple access 2000 1x.

10. The method of claim 1, wherein the predetermined registration tracking parameter is a tracking area code.

11. The method of claim 10, wherein the determining comprises determining not to update the registration status based at least in part on determining the tracking area code is a wildcard tracking area code.

12. The method of claim 11, wherein the determining is further based at least in part on a registration timer.

13. The method of claim 10, wherein the first radio access technology is third generation partnership project long term evolution and the second radio access technology is Global System for Mobile Communications or Universal Mobile Telecommunication System.

14. An apparatus operable in wireless communications, comprising:
at least one processor configured to:
determine a value for a predetermined registration tracking parameter from a base station of a first radio access technology; and
determine whether to update a registration status for a second radio access technology based at least in part on the value for the predetermined registration tracking parameter; and
a memory coupled to the at least one processor.

15. The apparatus of claim 14, wherein the predetermined registration tracking parameter is a band class.

16. The apparatus of claim 15, wherein the at least one processor is further configured to update the registration status for the second radio access technology, and the at least one processor determines to update the registration status based at least in part on determining that the value is different from a band class parameter value of the second radio access technology.

17. The apparatus of claim 15, wherein the at least one processor is further configured to determine whether a timer related to updating the registration status is expired where the value indicates a wildcard band class, and the at least one processor determines whether to update the registration status further based at least in part on the timer.

18. The apparatus of claim 17, wherein the at least one processor determines to not update the registration status based at least in part on determining that the timer is expired.

19. The apparatus of claim 15, wherein the at least one processor determines to update the registration status based at least in part on determining that the value is a no-match band class.

20. The apparatus of claim 15, wherein the at least one processor determines the value for the band class at least in part by receiving the value for the band class from the base station.

21. The apparatus of claim 15, wherein the at least one processor determines the value for the band class based at least in part on an operating frequency for communicating with the base station.

22. The apparatus of claim 15, wherein the first radio access technology is third generation partnership project long term evolution and the second radio access technology is code division multiple access 2000 1x.

23. The apparatus of claim 14, wherein the predetermined registration tracking parameter is a tracking area code.

24. The apparatus of claim 23, wherein the at least one processor determines not to update the registration status based at least in part on determining the tracking area code is a wildcard tracking area code.

25. The apparatus of claim 24, wherein the at least one processor determines not to update the registration status further based at least in part on a registration timer.

26. The apparatus of claim 23, wherein the first radio access technology is third generation partnership project long term evolution and the second radio access technology is Global System for Mobile Communications or Universal Mobile Telecommunication System.

27. An apparatus operable in wireless communications, comprising:
means for determining a value for a predetermined registration tracking parameter from a base station of a first radio access technology; and
means for determining whether to update a registration status for a second radio access technology based at least in part on the value for the predetermined registration tracking parameter.

28. The apparatus of claim 27, wherein the predetermined registration tracking parameter is a band class.

29. The apparatus of claim 28, further comprising means for updating the registration status for the second radio access technology, wherein the means for determining whether to update the registration status determines to update the registration status based at least in part on determining that the value is different from a band class parameter value of the second radio access technology.

30. The apparatus of claim 28, further comprising means for managing a timer related to updating the registration status, wherein the means for determining whether to update the registration status determines whether to update the registration status further based at least in part on the timer where the value indicates a wildcard band class.

31. The apparatus of claim 30, wherein the means for determining whether to update the registration status determines to not update the registration status based at least in part on determining that the value is the wildcard band class and determining that the timer is expired.

32. The apparatus of claim 28, wherein the means for determining whether to update the registration status determines to update the registration status based at least in part on determining that the value is a no-match band class.

33. The apparatus of claim 28, wherein the means for determining the value for the band class determines the value for the band class at least in part by receiving the value for the band class from the base station.

34. The apparatus of claim 28, wherein the means for determining the value for the band class determines the value for the band class based at least in part on an operating frequency for communicating with the base station.

35. The apparatus of claim 28, wherein the first radio access technology is third generation partnership project long term evolution and the second radio access technology is code division multiple access 2000 1x.

36. The apparatus of claim 27, wherein the predetermined registration tracking parameter is a tracking area code.

37. The apparatus of claim 36, wherein the means for determining whether to update the registration status determines to not update the registration status based at least in part on determining the tracking area code is a wildcard tracking area code.

38. The apparatus of claim 37, wherein the means for determining whether to update the registration status determines to not update the registration status based further at least in part on a registration timer.

39. The apparatus of claim 36, wherein the first radio access technology is third generation partnership project long term evolution and the second radio access technology is Global System for Mobile Communications or Universal Mobile Telecommunication System.

40. A computer program product used in wireless communications, comprising:
a computer-readable medium, comprising:
code for causing at least one computer to determine a value for a predetermined registration tracking parameter from a base station of a first radio access technology; and
code for causing the at least one computer to determine whether to update a registration status for a second radio access technology based at least in part on the value for the predetermined registration tracking parameter.

41. The computer program product of claim 40, wherein the predetermined registration tracking parameter is a band class.

42. The computer program product of claim 41, wherein the computer-readable medium further comprises code for causing the at least one computer to update the registration status for the second radio access technology, and the code for causing the at least one computer to determine whether to update the registration status determines to update the registration status based at least in part on determining that the value is different from a band class parameter value of the second radio access technology.

43. The computer program product of claim 41, wherein the computer-readable medium further comprises code for causing the at least one computer to determine whether a timer related to updating the registration status is expired where the value indicates a wildcard band class, and the code for causing the at least one computer to determine whether to update the registration status determines whether to update the registration status further based at least in part on the timer.

44. The computer program product of claim 43, wherein the code for causing the at least one computer to determine whether to update the registration status determines to not update the registration status based at least in part on determining that the timer is expired.

45. The computer program product of claim 41, wherein the code for causing the at least one computer to determine whether to update the registration status determines to update the registration status based at least in part on determining that the value is a no-match band class.

46. The computer program product of claim 41, wherein the code for causing the at least one computer to determine the value for the band class receives the value for the band class from the base station.

47. The computer program product of claim 41, wherein the code for causing the at least one computer to determine the value for the band class determines the value for the band class based at least in part on an operating frequency for communicating with the base station.

48. The computer program product of claim 41, wherein the first radio access technology is third generation partnership project long term evolution and the second radio access technology is code division multiple access 2000 1x.

49. The computer program product of claim 40, wherein the predetermined registration tracking parameter is a tracking area code.

50. The computer program product of claim 49, wherein the code for causing the at least one computer to determine whether to update the registration status determines not to update the registration status based at least in part on determining the tracking area code is a wildcard tracking area code.

51. The computer program product of claim 50, wherein the code for causing the at least one computer to determine whether to update the registration status determines not to update the registration status further based at least in part on a registration timer.

52. The computer program product of claim 49, wherein the first radio access technology is third generation partnership project long term evolution and the second radio access technology is Global System for Mobile Communications or Universal Mobile Telecommunication System.

53. An apparatus operable in wireless communications, comprising:
a parameter determining component for determining a value for a predetermined registration tracking parameter from a base station of a first radio access technology; and
a registration determining component for determining whether to update a registration status for a second radio access technology based at least in part on the value for the predetermined registration tracking parameter.

54. The apparatus of claim 53, wherein the predetermined registration tracking parameter is a band class.

55. The apparatus of claim 54, further comprising a registering component for updating the registration status for the second radio access technology, wherein the registration determining component determines to update the registration status based at least in part on determining that the value is different from a band class parameter value of the second radio access technology.

56. The apparatus of claim 54, further comprising a timer component for managing a timer related to updating the registration status, wherein the registration determining component determines whether to update the registration status further based at least in part on the timer where the value indicates a wildcard band class.

57. The apparatus of claim 56, wherein the registration determining component determines to not update the registration status based at least in part on determining that the value is the wildcard band class and determining that the timer is expired.

58. The apparatus of claim 54, wherein the registration determining component determines to update the registration status based at least in part on determining that the value is a no-match band class.

59. The apparatus of claim 54, wherein the parameter determining component determines the value for the band class at least in part by receiving the value for the band class from the base station.

60. The apparatus of claim 54, wherein the parameter determining component determines the value for the band class based at least in part on an operating frequency for communicating with the base station.

61. The apparatus of claim 54, wherein the first radio access technology is third generation partnership project long term evolution and the second radio access technology is code division multiple access 2000 1x.

62. The apparatus of claim 53, wherein the predetermined registration tracking parameter is a tracking area code.

63. The apparatus of claim 62, wherein the registration determining component determines to not update the registration status based at least in part on determining the tracking area code is a wildcard tracking area code.

64. The apparatus of claim 63, wherein the registration determining component determines to not update the registration status based further at least in part on a registration timer.

65. The apparatus of claim 62, wherein the first radio access technology is third generation partnership project long term evolution and the second radio access technology is Global System for Mobile Communications or Universal Mobile Telecommunication System.

66. A method operable by a device a wireless network, comprising:
detecting switching from idle-mode to active-mode communications;
determining that a time between a current time and a time for updating a registration status with a radio access technology is less than a threshold time; and
updating the registration status with the radio access technology while in active-mode communications based at least in part on the determining.

67. The method of claim 66, further comprising receiving the threshold time from a hardcoding, a configuration, or a base station.

68. The method of claim 66, wherein the updating the registration status with the radio access technology is performed while communicating over a different radio access technology.

69. An apparatus operable in a wireless network, comprising:
at least one processor configured to:
detect switching from idle-mode to active-mode communications;
determine that a time between a current time and a time for updating a registration status with a radio access technology is less than a threshold time; and
update the registration status with the radio access technology while in active-mode communications based at least in part on the at least one processor determining the time between the current time and the time for updating the registration status is less than the threshold time; and
a memory coupled to the at least one processor.

70. The apparatus of claim 69, wherein the at least one processor is further configured to receive the threshold time from a hardcoding, a configuration, or a base station.

71. The apparatus of claim 69, wherein the at least one processor updates the registration status with the radio access technology while communicating over a different radio access technology.

72. An apparatus operable in a wireless network, comprising:
means for detecting switching from idle-mode to active-mode communications and determining that a time between a current time and a time for updating a registration status with a radio access technology is less than a threshold time; and
means for updating the registration status with the radio access technology while in active-mode communications based at least in part on the means for detecting determining that the time between the current time and the time for updating the registration status is less than the threshold time.

73. The apparatus of claim 72, further comprising means for receiving the threshold time from a hardcoding, a configuration, or a base station.

74. The apparatus of claim 72, wherein the means for updating updates the registration status with the radio access technology while communicating over a different radio access technology.

75. A computer program product used in a wireless network, comprising:
a computer-readable medium, comprising:
code for causing at least one computer to detect switching from idle-mode to active-mode communications;
code for causing the at least one computer to determine that a time between a current time and a time for updating a registration status with a radio access technology is less than a threshold time; and
code for causing the at least one computer to update the registration status with the radio access technology while in active-mode communications based at least in part on the code for causing the at least one computer to determine determining the time between the current time and the time for updating the registration status is less than the threshold time.

76. The computer program product of claim 75, wherein the computer-readable medium further comprises code for causing the at least one computer to receive the threshold time from a hardcoding, a configuration, or a base station.

77. The computer program product of claim 75, wherein the code for causing the at least one computer to update updates the registration status with the radio access technology while communicating over a different radio access technology.

78. An apparatus operable a wireless network, comprising:
a registration determining component for detecting switching from idle-mode to active-mode communications and determining that a time between a current time and a time for updating a registration status with a radio access technology is less than a threshold time; and
a registering component for updating the registration status with the radio access technology while in active-mode communications based at least in part on the means for detecting determining that the time between the current time and the time for updating the registration status is less than the threshold time.

79. The apparatus of claim 78, further comprising a parameter receiving component for obtaining the threshold time from a hardcoding, a configuration, or a base station.

80. The apparatus of claim 78, wherein the registering component updates the registration status with the radio access technology while communicating over a different radio access technology.
